(19) United States
(12) Patent Application Publication
(10) Pub. No.: US 2004/0125086 A1
(43) Pub. Date: Jul. 1, 2004

(54) Touch input device having removable overlay

(76) Inventors: Edward S. Hagermoser, Lancaster, MA (US); Anthony L. Hill, River Falls, WI (US)

Correspondence Address: 3M INNOVATIVE PROPERTIES COMPANY, PO BOX 33427, ST. PAUL, MN, 55133-3427, US

(21) Appl. No.: 10/334,024

(22) Filed: Dec. 30, 2002

(51) Int. Cl. G09G 5/00

(52) U.S. Cl. 345/173

(57) ABSTRACT

Disclosed is a touch input device that includes a removable overlay defining the touch surface coupled to a plurality of sensors configured to sense the location of a touch based on forces due to the touch passing through the overlay. The overlay can be removed and replaced, for example to repair a damaged overlay.

This invention relates to touch input devices. In particular, the invention relates to touch input devices incorporating force-based touch input detection and having a removable overlay.

### BACKGROUND

Electronic displays are widely used in all aspects of life. Although in the past the use of electronic displays has been primarily limited to computing applications such as desktop computers and notebook computers, as processing power has become more readily available, such capability has been integrated into a wide variety of applications. For example, it is now common to see electronic displays in a wide variety of applications such as teller machines, gaming machines, automotive navigation systems, restaurant management systems, grocery store checkout lines, gas pumps, information kiosks, and hand-held data organizers to name a few.

### SUMMARY OF THE INVENTION

Generally, the present invention relates to a touch input device that includes sensors disposed to sense a location of a touch applied to a touch surface based on forces passed through a removable rigid overlay that is coupled to the sensors and that defines the touch surface.

In some embodiments, the touch input device of the present invention may be a component of a touch display system that includes a display that is viewable through the touch device. A processor can be coupled to the sensors and display for altering displayed information in response to a touch input. In some embodiments, the touch input device may be used with static graphics instead of or in addition to a changeable display. In some embodiments, the touch input device need not be transparent, for example when used as a touch pad or mouse emulation device in a computer system.

The present invention also relates to a method for repairing a touch input device of the present invention. The method includes inspecting the removable overlay for criteria that would indicate removal and removing the overlay. The overlay can then be replaced.

The above summary of the present invention is not intended to describe each disclosed embodiment or every implementation of the present invention. The Figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 illustrates a touch display system that includes a touch input device in accordance with one particular embodiment of the invention;

FIG. 2 is a partial view illustrating a touch input device that includes a force sensor and a removable overlay in accordance with one particular embodiment of the invention;

FIG. 3 illustrates an embodiment of a force sensor in accordance with one particular embodiment of the invention; and

FIG. 4 illustrates steps in a method in accordance with one particular embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The present invention relates to touch input devices that determine touch location using sensors that output signals based on forces passing through the sensors. The sensors are coupled to an overlay that provides a touch surface. When a touch is applied to the touch surface, the forces from the touch input are passed through the overlay to the sensors. The relative amount of force passing through each force sensor can be used to determine the location of the touch input.

The present invention further relates to such a touch input device where the touch surface can be decoupled from the sensors by removing the overlay from the device. A new or freshened touch surface can be provided by replacing the overlay or installing a new overlay, thereby restoring the device to a functioning condition. In some embodiments, the touch input device includes multiple, stacked overlays so that removal of the top overlay can reveal a new touch surface without replacing the original overlay or installing a new overlay.

It may be desirable to remove an overlay for cleaning, repair, or maintenance of the device. The same overlay can then be reinstalled or can be replaced with a new overlay if the original overlay has been damaged or worn or otherwise lacks desirable features present in the new overlay. As such, the overlay is field replaceable and removable for cleaning and repair. The construction of force-based touch input devices of the present invention lends itself well to a removable overlay because the overlay can be removed in the field without necessarily removing or otherwise disrupting electronic components of the device. The removable overlay can be economically constructed and need not (although it may) include any electronic components so that removal and replacement are not only straight forward, but can be accomplished relatively cheaply. This can be contrasted with conventional touch screens in which replacement of the entire touch device is typically required if the touch surface is damaged and a new touch surface is desired. Because the present invention provides a removable overlay that defines the touch surface, it is well-suited to applications such as public kiosks where the touch input device may be particularly susceptible to damage due to frequent rough use or vandalism.

The removable overlay can be a simple sheet of suitable material. In exemplary embodiments, the overlay includes a minimum of electrical components, sensor components, or other components that would increase the cost or complexity of the overlay, although the overlay may include various layers or components that add functionality. Exemplary overlays can include transparent glass or rigid plastic for applications where it is desirable to view a display, graphics, or other objections through the touch input device. When glass is used, it may be desirable to use laminated or otherwise impact-resistant glass. Polycarbonates or polyacrylates may provide suitable transparent rigid plastic overlays. In embodiments where transparency is not required, metal plates and rigid plastics may provide suitable overlay materials. When opaque overlays are used, the overlay can be made to have a uniform appearance or can include graphics, indicia, coloration effects, and the like. The overlay is preferably sufficiently rigid so that forces normal to the touch surface can be transmitted as normal forces through the overlay to the force sensors. The overlay can optionally include various films and coatings including optical coatings that enhance contrast, provide anti-glare or anti-reflection, and the like, anti-smudge coatings, anti-microbial coatings, microtextured films or coatings (for example, to provide enhanced tactile feedback), and so forth.

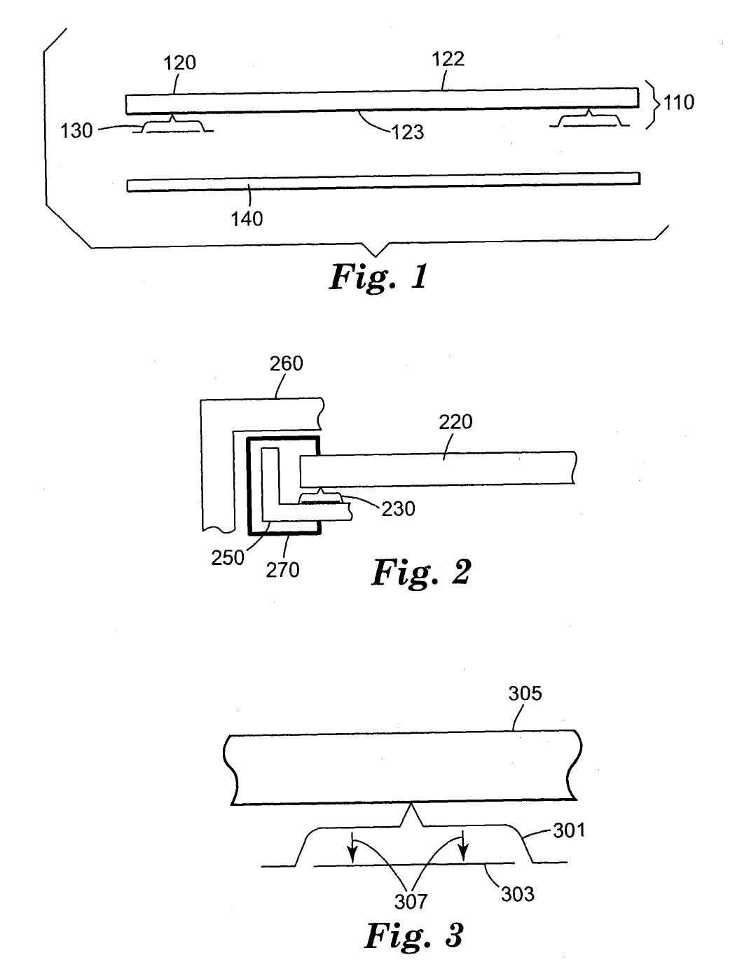

FIG. 1 shows a touch display system 100 that includes a touch input device 110 and an optional display 140. Optional display 140 is shown to be viewable through touch input device 110. Touch input device 110 includes a plurality of force sensors 130 and a removable overlay 120 coupled to the force sensors 130. Overlay 120 defines touch surface 122.

When a point on the touch surface 122 is touched, a force will be imparted through the overlay 120 to the force sensors 130. By measuring the relative magnitudes of the forces at the location of the sensors, a position of the touch can be deterinined. One advantage of such an arrangement is that the location of the touch can be determined independent of the instrument used to touch the surface 122. For example, a stylus may be used, a finger may be used, or a finger wearing a glove. In each instance, the force sensors 130 will register a touch on the surface 122 of the overlay 120 in a similar manner. At least two force sensors are required to determine touch location along one direction, and three or more force sensors are required to deterimine both the x and y coordinates of a touch input. In cases where a display is meant to be viewed through the touch input device, it may be convenient to locate the sensors near the border of the device. For example, a force sensor can be located at each of the four corners of a rectangular touch device or along each of its four edges.

The force sensors, as well as the housing and other elements (not shown) are preferably the force sensors described in International Publications WO 2002/084580, WO 2002/084579, WO 2002/084578, and WO 2002/084244, all of which are incorporated herein by reference.

The optional display 140 can be any of a variety of known displays. For example, the display may be a liquid crystal display, a cathode ray tube display, an electroluminescent display such as an organic electroluminescent display, an inorganic electroluminescent display, a plasma display, or any other suitable display including static graphics. The display 140 may be a segmented display, a pixilated display, a high information content or low information content display, and the like. The display may further be a multi-colored display, full-colored display, or a monochromatic display as desired in the particular application.

Besides providing a touch surface, the surface 122 of the overlay 120 may provide additional functionality. For example, structures may be incorporated into the surface 122 and/or surface 123 that serve to redirect or focus light emitted from the display. Structures may also be included to impart a texture to the surface 122 of the overlay 120 to provide a more tactilely accurate surface for writing or otherwise using a writing implement on the surface.

The overlay 120 may further incorporate contrast enhancement functionality. For example, a circular polarizer may be laminated or otherwise attached to the either side of the overlay. The circular polarizer can function to provide contrast enhancement when the display is used in conditions where a significant amount of ambient light is present. As an alternative, color filters may be used for contrast enhancement. Color filters are particularly well suited for use with monochrome or segmented color displays. In such a system, a filter designed to absorb all wavelengths of light other than that emitted by the particular display (or segment) is disposed over the display. The above described contrast enhancement color filters are known to those of skill in the art.

The surface 122 (or 123) of removable overlay 120 may also be treated to have anti-reflective properties. For example, various coatings of different materials having different refractive indices may be used to decrease the amount of reflection. Alternatively, or in addition to the anti-reflection, the surface 122 (or 123) may be provided with an anti-glare surface. The anti-glare surface may be achieved by etching the surface 122 (or 123) of the overlay, or by laminating or otherwise adhering a textured surface onto the overlay. Alternatively, an anti-glare coat may be sprayed directly onto the surface of the overlay.

The surface 122 of the overlay 120 may also be treated with other functional layers. For example, a low surface energy material may be applied to the surface in order to increase cleanability of the overlay. A hardcoat may be applied to the surface 122 to improve durability of the device in response to multiple touches. An anti-microbial treatment may also be applied to the surface of the overlay as described in co-pending International Publication WO 00/20917, the contents of which are incorporated herein by reference. Also, thin polymer films may be laminated to or otherwise disposed on surface 122, for example to provide resistance to damage.

FIG. 2 shows a partial schematic side view of an assembly that includes a touch input device of the present invention. Overlay 220 is removably coupled to force sensor 230, which is supported by frame 250. Bezel 260 covers the assembly. Frame 250 is shown to have an “L” shaped cross-section, although other frames may be suitably used. Frame 250 provides a mounting surface for the force sensors such as sensor 230. Overlay 220 is shown directly contacting the upper portion of sensor 230, although the overlay 220 may be coupled to the force sensors through intermediary layers or materials, provided that touch forces are adequately passed through the overlay and such intermediaries to the force sensors so that touch location can be determined to a desired accuracy. Overlay 220 is not attached to the force sensors so that the overlay can be decoupled from the sensors and removed from the assembly.

Overlay 220 can be releasably attached to the assembly in any suitable manner that allows relatively free motion of the overlay in response to touch forces that are normal to the touch surface while at the same time confining the overlay so that it does not fall out of the assembly. For example, optional clips 270 can be used that engage both the frame 250 and the overlay 220 to hold the assembly together and that allow normal motion of the overlay under touch forces. Overlay 220 may be removed by detaching the bezel 260 and disengaging the clips 270. Because the overlay is not attached to the sensors, the overlay can then be removed for cleaning of the assembly, for replacement of the overlay, or for repair or replacement of other components of the device. As another example, preload springs can be disposed to engage both the overlay and the frame in such a manner as to hold the assembly together. Suitable preload springs may take the form of bent wires that engage apertures in the frame and that contact the overlay at its edges, such as shown and described in International Publication WO 02/084244, the disclosure of which is wholly incorporated into this document.

In some cases, it may be desirable to include a seal between bezel 260 and frame 250, or between bezel 260 and overlay 220. When a seal is included, it should be one that allows overlay 220 to be removed.

The force sensors that may be used in connection with one particular embodiment of the present invention is illustrated in FIG. 3. The distance of a touch from each of the sensors can be determined using the magnitude of the force sensed by each of the sensors. Three or more touch sensors can be used to determine the location of a touch in both the x and y direction of the plane of the touch surface. It is generally preferable to have four or more touch sensors as described in the above-referenced International Publications WO 2002/084580, WO 2002/084579, WO 2002/084578, and WO 2002/084244. The force sensor depicted in FIG. 3 includes two conductive elements. The first conductive element 301 is formed of a metal material having a generally spring like behavior. The metal material forms a peak, which contacts the bottom surface of an element 305 (for example, the removable overlay) sitting on the force sensor. As described previously in connection with FIGS. 1 and 2, the bottom surface may be the removable overlay.

A second conductive element 303 is provided beneath the first conductive element 301. As a force is applied to element 305, the first conductive element 301 is displaced in a downward direction as indicated by arrows 307. In this manner, the first conductive element 301 is brought closer to the second conductive element 303. In this configuration, the conductive elements 301 and 303 are arranged to function as a capacitor. As the top portion of the first conductive element 301 is displaced towards the second conductive element 303, a change in capacitance is determined. This change in capacitance can be used to determine the amount of force applied to the particular sensor. As described above, when multiple sensors are used, one can then determine the relative forces applied to each of the sensors, and hence, the location of a touch.

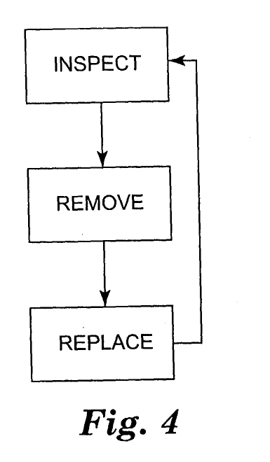

FIG. 4 shows a flow of steps in a process of replacing an overlay in a touch input device of the present invention. When such a touch input device is being used as part of a display system, the device may be inspected for criteria that would indicate replacement of the overlay is desired. For example, if the overlay is worn, damaged (for example, cracked or broken), vandalized, or otherwise no longer conforms to desired specifications, removal and replacement of the overlay may be indicated. If such criteria are present, the overlay can be removed and then replaced with another overlay that places the device back into conformance with specifications, or initially into conformance with new performance specifications. These steps can be repeated as necessary or as desired.

The advantages of the present invention will be appreciated from the above description. The invention should not be considered limited to the preferred embodiments. Alternative embodiments may be readily apparent to the skilled artisan upon review of the present specification. For example, other functionality may be incorporated into the touch surface. A variety of end use applications of the described touch display will also become apparent.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

What is claimed is:

1. A touch input device comprising:
a plurality of sensors disposed to sense a location of a touch applied to a touch surface based on forces passed through a rigid overlay that is coupled to the sensors and that defines the touch surface, the overlay being configured to be decoupled from the sensors, removed from the touch input device, and replaced.

2. A touch input device as recited in claim 1, wherein the overlay comprises glass.

3. A touch input device as recited in claim 1, wherein the overlay comprises a rigid plastic.

4. A touch input device as recited in claim 1, wherein the overlay comprises a metal plate.

5. A touch input device as recited in claim 1, wherein the overlay comprises structures to focus or redirect light.

6. A touch input device as recited in claim 1, wherein the overlay comprises a contrast enhancement layer.

7. A touch input device as recited in claim 6, wherein the contrast enhancement layer comprises a circular polarizer.

8. A touch input device as recited in claim 6, wherein the contrast enhancement layer comprises a color filter.

9. A touch input device as recited in claim 1, wherein the overlay is transparent.

10. A touch input device as recited in claim 1, wherein the overlay comprises graphics or other indicia.

11. A touch input device as recited in claim 1, further comprising an inertial sensor disposed to sense inertial forces applied to the device.

12. A touch input device as recited in claim 1, wherein the sensors comprise two conductive elements spaced apart to form a capacitor the output signals of the force sensors represents relative movement of the two conductive elements.

13. A touch input device as recited in claim 1, wherein removal of the overlay reveals a second overlay providing a new touch surface.

14. A touch input system comprising:
a plurality sensors configured to output signals representative of forces applied to the sensors, the sensors being arranged to receive forces passing through a rigid overlay that is coupled to the sensors, the overlay being configured to be decoupled from the sensors, removed and replaced;
a display element disposed to be viewable through the overlay; and
a processor coupled to the sensors to determine a location of a touch applied to the overlay based on the output signals and for altering information displayed on the display element in response to the touch.

15. A method for repairing a touch input device comprising:
providing a touch input device comprising a rigid overlay coupled to a plurality of sensors disposed to sense a location of a touch based on forces due to the touch that are passed through the overlay to the sensors;
inspecting the overlay for condition; and
removing the overlay without disrupting the sensors.

16. The method of claim 15, further comprising replacing the overlay.

17. The method of claim 16, wherein replacing the overlay comprises reinstalling the same overlay.

18. The method of claim 16, wherein replacing the overlay comprises installing a new overlay.

19. The method of claim 15, wherein removing the overlay reveals a second rigid overlay.
